(19) United States
(12) Patent Application Publication
(10) Pub. No.: US 2025/0078469 A1
(43) Pub. Date: Mar. 6, 2025

(54) DEFORMABLE CONVOLUTION-BASED DETAIL RESTORATION FOR SINGLE-IMAGE HIGH DYNAMIC RANGE (HDR) RECONSTRUCTION

(71) Applicant: Samsung Electronics Co., Ltd., Suwon-si (KR)

(72) Inventors: Joonsoo Kim, Irvine, CA (US); Tien Bau, Irvine, CA (US)

(21) Appl. No.: 18/734,953

(22) Filed: Jun. 5, 2024

Related U.S. Application Data
(60) Provisional application No. 63/535,278, filed on Aug. 29, 2023.

(51) Int. Cl. G06V 10/771; G06T 3/40; G06T 5/20; G06V 10/80

(52) U.S. Cl. CPC G06V 10/771; G06T 3/40; G06T 5/20; G06V 10/806

(57) ABSTRACT

A method includes obtaining, using at least one processing device of an electronic device, an input image. The method also includes performing, using the at least one processing device, single-image reconstruction based on the input image to generate a reconstructed output image, where the reconstructed output image has a higher dynamic range than the input image. Performing the single-image reconstruction includes restoring details to the input image based on deformable convolutions of feature maps associated with the input image.

### CROSS-REFERENCE TO RELATED APPLICATION AND PRIORITY CLAIM

This application claims priority under 35 U.S.C. § 119 (e) to U.S. Provisional Patent Application No. 63/535,278 filed on Aug. 29, 2023. This provisional patent application is hereby incorporated by reference in its entirety.

### TECHNICAL FIELD

This disclosure relates generally to image processing systems and processes. More specifically, this disclosure relates to deformable convolution-based detail restoration for single-image high dynamic range (HDR) reconstruction.

### BACKGROUND

Modern televisions and other display devices are capable of displaying images at high brightness and resolution levels. For example, some current display devices are capable of displaying images at peak brightness levels up to around 2,000 cd/m² and at resolutions up to 8K (7,680 pixels by 4,320 pixels). Moreover, it is expected that brightness levels and resolutions of display devices will continue to increase over time.

### SUMMARY

This disclosure relates to deformable convolution-based detail restoration for single-image high dynamic range (HDR) reconstruction.

In a first embodiment, a method includes obtaining, using at least one processing device of an electronic device, an input image. The method also includes performing, using the at least one processing device, single-image reconstruction based on the input image to generate a reconstructed output image, where the reconstructed output image has a higher dynamic range than the input image. Performing the single-image reconstruction includes restoring details to the input image based on deformable convolutions of feature maps associated with the input image. In another embodiment, a non-transitory machine readable medium includes instructions that when executed cause at least one processor of an electronic device to perform the method of the first embodiment.

In a second embodiment, an electronic device includes at least one processing device configured to obtain an input image and perform single-image reconstruction based on the input image to generate a reconstructed output image, where the reconstructed output image has a higher dynamic range than the input image. To perform the single-image reconstruction, the at least one processing device is configured to restore details to the input image based on deformable convolutions of feature maps associated with the input image.

In a third embodiment, a method includes obtaining, using at least one processing device of an electronic device, an input feature map and a condition map associated with an input image. The method also includes performing, using the at least one processing device, deformable convolutions of the input feature map based on the condition map to generate convolution results. The method further includes generating an output feature map based on the input feature map and the convolution results, where the output feature map includes one or more details of the input image missing from the input feature map. In another embodiment, an electronic device includes at least one processing device configured to perform the method of the third embodiment. In yet another embodiment, a non-transitory machine readable medium includes instructions that when executed cause at least one processor of an electronic device to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example architecture supporting deformable convolution-based detail restoration for single-image high dynamic range (HDR) reconstruction in accordance with this disclosure;

FIG. 3 illustrates an example condition network in the architecture of FIG. 2 in accordance with this disclosure;

FIG. 4 illustrates an example tone network in the architecture of FIG. 2 in accordance with this disclosure;

FIG. 5 illustrates an example restoration network in the architecture of FIG. 2 in accordance with this disclosure;

FIG. 6 illustrates an example deformable convolution residual block (DCRB) in the restoration network of FIG. 5 in accordance with this disclosure;

FIG. 7 illustrates an example spatial feature transform (SFT) layer in the restoration network of FIG. 5 and the DCRB of FIG. 6 in accordance with this disclosure;

FIG. 8 illustrates an example method for deformable convolution-based detail restoration for single-image HDR reconstruction in accordance with this disclosure; and

FIG. 9 illustrates an example method for using a DCRB in accordance with this disclosure.

### DETAILED DESCRIPTION

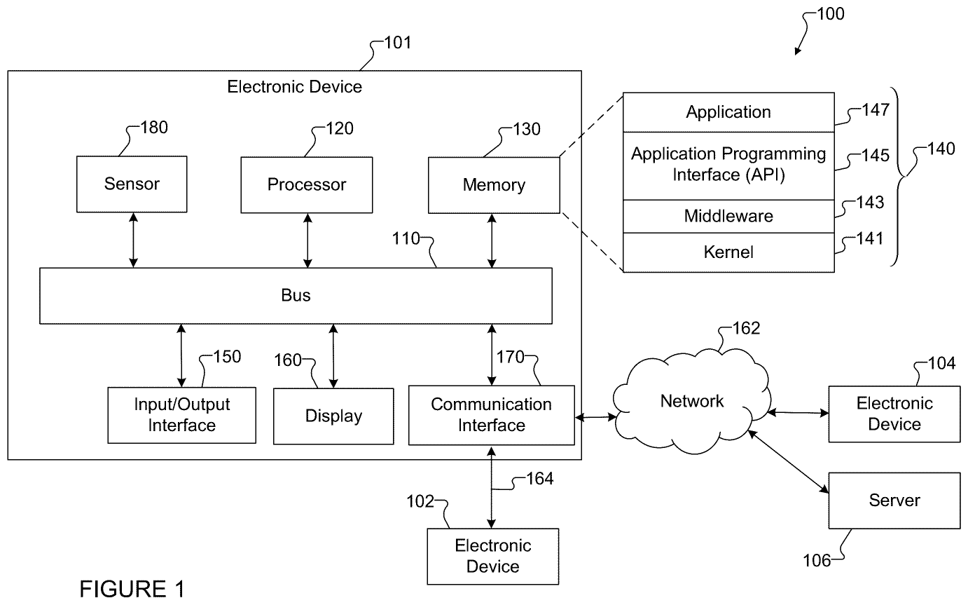

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, modern televisions and other display devices are capable of displaying images at high brightness and resolution levels. For example, some current display devices are capable of displaying images at peak brightness levels up to around 2,000 cd/m² and at resolutions up to 8K (7,680 pixels by 4,320 pixels). Moreover, it is expected that brightness levels and resolutions of display devices will continue to increase over time. With improvements in display devices, the demand for high-quality high dynamic range (HDR) images or videos with high resolutions has also increased. Unfortunately, the dominant video content currently available is still standard dynamic range (SDR) content. SDR content includes only low dynamic range (LDR) for HDR scenes, which causes loss of detail in bright (over-exposed) and dark (under-exposed) regions of the scenes. In addition, HDR video content captured by many consumer-grade electronic devices (such as smartphones) often cannot capture all details in very bright and very dark regions in HDR scenes due to hardware limitations, so the resulting images often include HDR image artifacts like ghosting and ringing.

To help resolve this, single-image HDR reconstruction techniques using deep neural networks have been proposed. These techniques enable the recreation of details in an HDR image from a single LDR image without requiring additional exposures or specialized hardware. Using multiple pairs of LDR and HDR training images, these networks can learn how to restore details in bright and dark regions, which allows missing details in those regions of an image to be restored. However, these techniques do not consider how large over-exposed or under-exposed regions are during image restoration. Instead, these techniques assume that over-exposed and under-exposed regions are small, such as when an over-exposed region is associated with a small light source.

This assumption is not generally true in the real world, and many scenes can include any number of over-exposed and/or under-exposed regions having widely-varying sizes. For example, many natural scenes can include very bright and large regions such as the sky, and these regions can easily become over-exposed when captured in images. Also, small bright objects such as light sources can be bigger when captured during zoom-in mode. Further, the number of pixels in over-exposed or under-exposed regions can increase as the image resolution increases. As a result, when the image resolution becomes large (such as 2K, 4K, or 8K), the number of pixels in over-exposed or under-exposed regions also increases, which can prevent prior techniques from being used effectively. In addition, partially over-exposed or under-exposed objects within a larger over-exposed or under-exposed region often cannot be restored correctly. For instance, some parts of power lines, trees, or other objects within an over-exposed background like the sky can be identified as being over-exposed because of the light source (the sun) behind the objects. Since the majority of the over-exposed region is the sky, existing techniques could restore the object regions as sky, which can create gaps in the objects or otherwise cause the objects to appear unnatural.

This disclosure provides various techniques supporting deformable convolution-based detail restoration for single-image HDR reconstruction. As described in more detail below, an input image can be obtained, and single-image reconstruction based on the input image can be performed to generate a reconstructed output image. The reconstructed output image can have a higher dynamic range than the input image. Performing the single-image reconstruction can include restoring details to the input image based on deformable convolutions of feature maps associated with the input image. In some cases, restoring the details to the input image can include generating offsets based on an input feature map, and the offsets can identify locations of neighboring pixels to be convolved during the deformable convolutions. Also, in some cases, a pipeline that performs the single-image reconstruction can be trained using a loss function, such as a loss function that represents a combination of a pixel loss and a perceptual loss. As also described in more detail below, an input feature map and a condition map associated with an input image can be obtained, and deformable convolutions of the input feature map can be performed based on the condition map to generate convolution results. An output feature map can be generated based on the input feature map and the convolution results, and the output feature map can include one or more details of the input image missing from the input feature map.

In this way, the described techniques can effectively perform single-image HDR reconstruction of input images. This allows images with higher dynamic ranges and higher resolutions to be generated, and the resulting images can have improved image details in brighter and darker regions of the images. Moreover, this can be accomplished while creating fewer artifacts in the resulting images. Among other things, these techniques can consider how large over-exposed and/or under-exposed regions are during the image restoration. These techniques can also properly restore partially over-exposed and/or under-exposed objects within larger over-exposed and/or under-exposed regions.

Note that there are various applications and use cases in which this functionality may be used. For example, televisions or other displays, set-top boxes, TV boxes, or other devices may use this functionality in order to increase the dynamic range and resolution of images to be displayed to viewers. This may be useful, for instance, when presenting existing LDR movies or other LDR content captured by older movie cameras or other cameras lacking high dynamic details. As another example, televisions or other displays, smartphones, or other devices may use this functionality in order to increase the dynamic range and resolution of images or videos captured using smartphone cameras or other cameras that can lose details in high dynamic scenes. As yet another example, content providers may use this functionality to increase the dynamic range and resolution of content to be provided to users, and the processed content may be stored, streamed, or otherwise used. In general, this disclosure is not limited to any particular applications and use cases for deformable convolution-based detail restoration for single-image HDR reconstruction. Also note that an architecture or pipeline providing a detail restoration network can be trained using one or more large image datasets, which can help the detail restoration network learn how to effectively generate high-quality images.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to deformable convolution-based detail restoration for single-image HDR reconstruction.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform deformable convolution-based detail restoration for single-image HDR reconstruction. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user. Note that in other embodiments, the display 160 may be external to the electronic device 101.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 may include one or more sensors 180 that can meter a physical quantity or detect an activation state of the electronic device 101 and convert metered or detected information into an electrical signal. For example, the sensor(s) 180 may include cameras or other imaging sensors, which may be used to capture images of scenes. The sensor(s) 180 may also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 may include one or more position sensors, such as an inertial measurement unit that can include one or more accelerometers, gyroscopes, and other components. In addition, the sensor(s) 180 may include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. In still other embodiments, the electronic device 101 can be a fixed or portable display device (such as a television) or an electronic device used in conjunction with a display device (such as a set-top box or TV box).

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to deformable convolution-based detail restoration for single-image HDR reconstruction.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

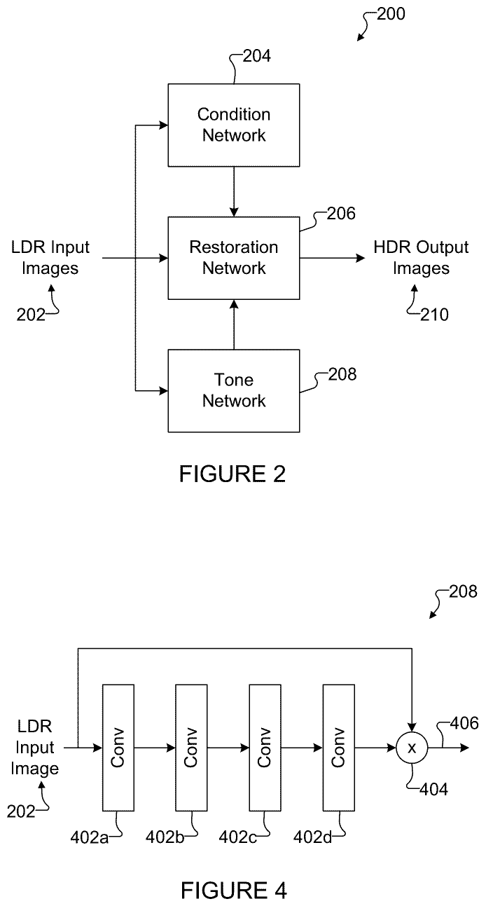

FIG. 2 illustrates an example architecture 200 supporting deformable convolution-based detail restoration for single-image HDR reconstruction in accordance with this disclosure. For case of explanation, the architecture 200 of FIG. 2 is described as being implemented using the electronic device 101 in the network configuration 100 of FIG. 1. However, the architecture 200 may be implemented using any other suitable device(s) and in any other suitable system(s).

As shown in FIG. 2, the architecture 200 generally operates to receive LDR input images 202 and generate HDR output images 210. The input images 202 may be obtained from any suitable source(s). As examples, the input images 202 may be captured using at least one camera or other imaging sensor 180 of the electronic device 101 or obtained over the Internet or other network via at least one communication interface 170 of the electronic device 101. Any suitable number of input images 202 may be obtained here, and the input images 202 may represent individual images or images contained in a stream of images (such as a video sequence). Each input image 202 can have any suitable format, such as a red-green-blue (RGB) image format, a luma-chroma (YUV) image format, or a Bayer or other raw image format. Each input image 202 can also have any suitable resolution. In some cases, each input image 202 can have a dynamic range that is lower than desired and/or a resolution that is lower than desired. Each output image 210 can also have any suitable format and any suitable resolution. Each output image 210 generally has a higher dynamic range (and possibly a higher resolution) than its corresponding input image 202.

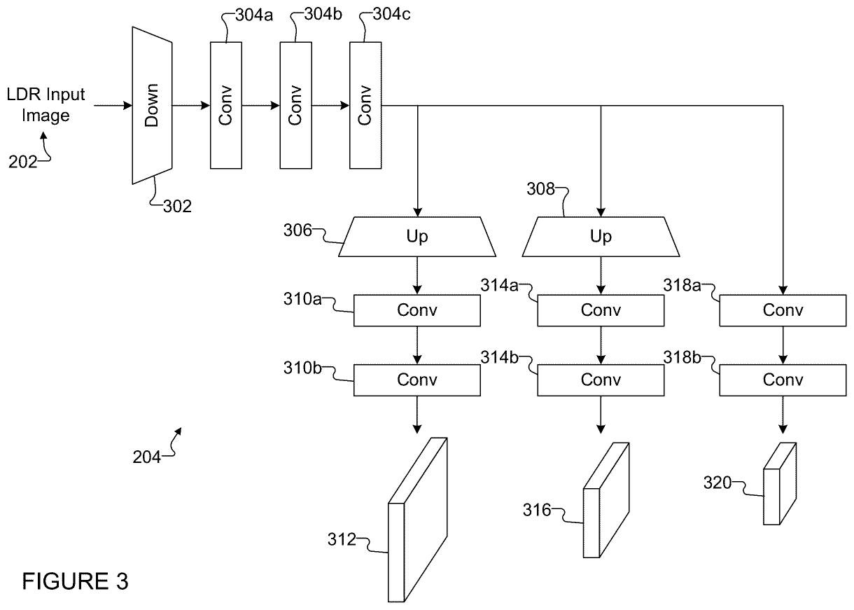

The input images 202 are provided to and processed by a condition network 204, a restoration network 206, and a tone network 208. The condition network 204 represents a trained machine learning model or other logic that is configured to identify one or more conditions within each of the input images 202. For example, the condition network 204 can be used to identify any region within each input image 202 that appears to be over-exposed or under-exposed. The condition network 204 can generate at least one condition map for each input image 202, and the condition map(s) for each input image 202 can identify if and where the one or more conditions exist within the input image 202. In some cases, each condition map may represent a binary map that indicates whether at least one condition is or is not present at each pixel location of the corresponding input image 202. In some embodiments, the condition network 204 may be used to generate multiple condition maps for each input image 202, such as when different condition maps for each input image 202 have different scales. The condition network 204 can use any suitable technique to generate condition maps for input images 202. One example embodiment of the condition network 204 is shown in FIG. 3, which is described below.

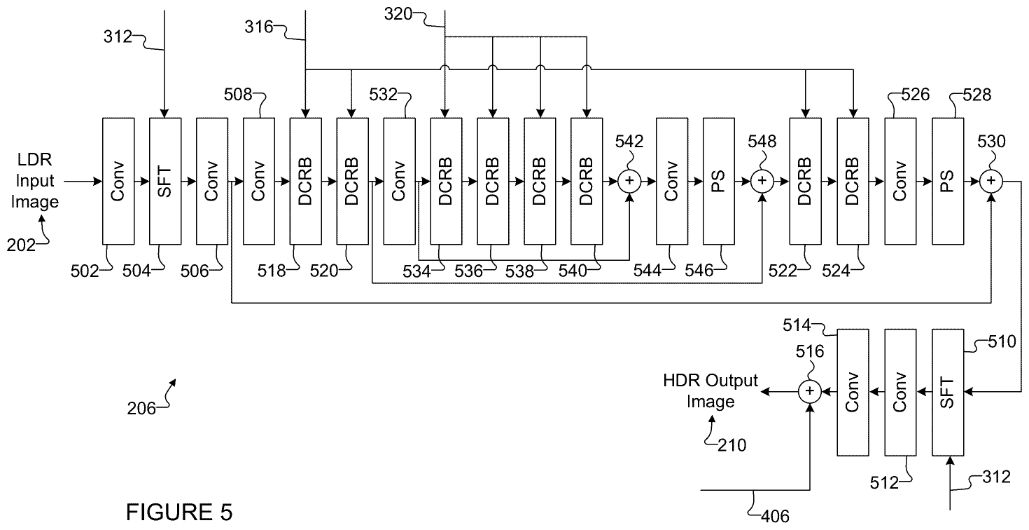

The restoration network 206 represents a trained machine learning model or other logic that is configured to restore image details that are missing from the input images 202. For example, the restoration network 206 can perform multiple convolutions, multiple spatial feature transforms, and multiple deformable convolution residual blocks to process the input images 202 and add details to the input images 202. In some cases, this can be accomplished by training the restoration network 206 using one or more training datasets containing training pairs, where each training pair includes an LDR training image and an HDR ground truth image. Using these images, the restoration network 206 can be trained to process the LDR training images and generate output images that are compared to the corresponding HDR ground truth images. Differences between the output images and the corresponding HDR ground truth images are used to calculate a loss. Weights or other parameters of the restoration network 206 can be adjusted during the training so that the restoration network 206 generates output images that are substantially similar to the corresponding HDR ground truth images, meaning the loss generally decreases over time and eventually falls to a suitably-low value indicative of the restoration network 206 operating with at least a desired level of accuracy. Among other things, the restoration network 206 can be trained to restore image details in darker and brighter portions of the input images 202, which can help to increase the dynamic range of the resulting output images 210. The restoration network 206 can use any suitable technique to restore details to input images 202. One example embodiment of the restoration network 206 is shown in FIG. 5, which is described below.

The tone network 208 represents a trained machine learning model or other logic that is configured to identify how to adjust the tone of the images generated by the restoration network 206 so that the resulting output images 210 have proper tone. For example, there are generally tonal differences between over-exposed/under-exposed regions and normal-exposed regions in LDR and HDR images. The tone network 208 processes the input images 202 and determines how the tone of the images generated by the restoration network 206 should be adjusted. Among other things, the tone network 208 can determine how to adjust the tone in different regions of the images generated by the restoration network 206 so that the overall tone in all regions generally match one another. The tone network 208 can use any suitable technique to adjust tone in images. One example embodiment of the tone network 208 is shown in FIG. 4, which is described below.

The resulting output images 210 generated by the architecture 200 may be used in any suitable manner, and the specific manner of use can vary depending on the implementation. For example, in some embodiments, the output images 210 may be displayed on one or more displays 160 of the electronic device 101 or on one or more displays of another device. In other embodiments, the output images 210 may be stored, such as in the memory 130 of the electronic device 101 or in the memory of another device, for later use. In general, this disclosure is not limited to any specific use of the output images 210.

Although FIG. 2 illustrates one example of an architecture 200 supporting deformable convolution-based detail restoration for single-image HDR reconstruction, various changes may be made to FIG. 2. For example, various components or functions in FIG. 2 may be combined, further subdivided, replicated, omitted, or rearranged and additional components or functions may be added according to particular needs.

FIG. 3 illustrates an example condition network 204 in the architecture 200 of FIG. 2 in accordance with this disclosure. As shown in FIG. 3, the condition network 204 receives and processes the input images 202. The condition network 204 includes a down-sampling function 302, which decreases the amount of image data contained in each input image 202 being processed. The down-sampling function 302 can use any suitable technique to reduce the amount of image data in each input image 202, such as bicubic down-sampling. The down-sampling function 302 can also provide any suitable reduction in the amount of image data contained in each input image 202, such as by reducing the amount of image data by 75%.

Convolutional layers 304a-304c process the down-sampled image data for each input image 202 and apply convolutions to the down-sampled image data in order to generate convolution results, which take the form of feature maps associated with the input images 202. In general, the convolutional layers 304a-304c are used to extract features from the input images 202 that have been determined during training to be relevant to the specific task at hand (such as identifying the condition of the input images 202). In some cases, each convolutional layer 304a-304c can include or be used in conjunction with a leaky rectified linear unit (ReLU) that generates the convolution results for that convolutional layer. Note that the number of convolutional layers 304a-304c shown in FIG. 3 is for illustration only, and other numbers of convolutional layers 304a-304c may be used here. Each convolutional layer 304a-304c can include a kernel that functions as a filter, and the filter can move by a specified amount (referred to as the stride) within each input image 202. In some embodiments, each convolutional layer 304a-304c may include a 3×3 kernel that operates with a stride of one.

An up-sampling function 306 increases the amount of data in the feature maps output by the last convolutional layer 304c, and an up-sampling function 308 also increases the amount of data in the feature maps output by the last convolutional layer 304c (but by a smaller amount compared to the up-sampling function 306). As a result, each of the up-sampling functions 306 and 308 can be used to generate up-sampled convolution results. Each of the up-sampling functions 306 and 308 can use any suitable technique to increase the amount of data contained in feature maps, such as bicubic up-sampling. Each of the up-sampling functions 306 and 308 may also provide any suitable increase in the amount of data in each feature map, such as when the up-sampling function 306 quadruples the amount of data contained in each feature map and the up-sampling function 308 doubles the amount of data contained in each feature map. This results in the generation of feature maps having different scales. That is, the feature maps generated by the up-sampling function 308 can have double the scale of the feature maps output by the last convolutional layer 304c. The feature maps generated by the up-sampling function 306 can have double the scale of the feature maps generated by the up-sampling function 308 and quadruple the scale of the feature maps output by the last convolutional layer 304c.

Convolutional layers 310a-310b process the up-sampled feature maps from the up-sampling function 306 and apply convolutions to the up-sampled feature maps in order to generate a condition map 312. Convolutional layers 314a-314b process the up-sampled feature maps from the up-sampling function 308 and apply convolutions to the up-sampled feature maps in order to generate a condition map 316. Convolutional layers 318a-318b process the (non-up-sampled) feature maps from the last convolutional layer 304c and apply convolutions to the feature maps in order to generate a condition map 320. The convolutional layers 310a-310b, 314a-314b, 318a-318b are used to extract features of the input images 202 that have been determined during training to be relevant to the specific task at hand (such as identifying the condition of the input images 202). In some cases, each convolutional layer 310a, 314a, 318a can include or be used in conjunction with a leaky ReLU and each convolutional layer 310b, 314b, 318b can include a ReLU that generate the convolution results for the convolutional layers. Note that the numbers of convolutional layers 310a-310b, 314a-314b, 318a-318b shown in FIG. 3 are for illustration only, and other numbers of convolutional layers 310a-310b, 314a-314b, 318a-318b may be used here. In some embodiments, each convolutional layer 310a-310b, 314a-314b, 318a-318b may include a 3×3 kernel that operates with a stride of one.

Each condition map 312, 316, 320 identifies one or more conditions of the associated input image 202, such as by identifying locations where each input image 202 is over-exposed and/or under-exposed. Due to the different scales of feature maps provided to the three branches of the condition network 204, the condition maps 312, 316, 320 also have different scales. For example, the condition map 316 can be double the scale of the condition map 320, and the condition map 312 can be double the scale of the condition map 316 and quadruple the scale of the condition map 320. By providing the condition maps 312, 316, 320 at different scales, the restoration network 206 can reconstruct details for different image contents more adaptively. Note that performing the down-sampling and up-sampling here can make the condition maps 312, 316, 320 smoother and allow the condition maps 312, 316, 320 to be generated with larger neighbor regions.

In some embodiments, given an input image 202 (denoted I_{LDR}), each condition map 312, 316, 320 at each scale for that input image 202 may be defined as follows.

$$Net \_C ( I\_LDR ) = cv \hat{} 2 ( up \_ ( 1 / s ) ( cv \hat{} 3 ( d\_ 4 ( I\_LDR ) ) )$$

Here, Net_{C}( ) represents operation of the condition network 204, and s represents the scale (such as when s∈{1, 0.5, 0.25}). Also, d₄( ) represents operation of the down-sampling function 302, and up_{1/s}( ) represents operation of either the up-sampling function 306 or 308 (for the condition maps 312, 316) or no up-sampling function (for the condition maps 320). In addition, cv²( ) represents operation of the two convolutional layers 310a-310b, 314a-314b, or 318a-318b, and cv³ ( ) represents operation of the convolutional layers 304a-304c.

Although FIG. 3 illustrates one example of a condition network 204 in the architecture 200 of FIG. 2, various changes may be made to FIG. 3. For example, various components or functions in FIG. 3 may be combined, further subdivided, replicated, omitted, or rearranged and additional components or functions may be added according to particular needs. As a particular example, while the condition network 204 is shown as generating condition maps at three scales, condition maps may be generated at any other suitable number of scales.

FIG. 4 illustrates an example tone network 208 in the architecture 200 of FIG. 2 in accordance with this disclosure. As shown in FIG. 4, the tone network 208 receives and processes the input images 202. Convolutional layers 402a-402d process the input images 202 and apply convolutions to the input images 202 in order to generate convolution results. In some cases, each convolutional layer 402a-402c can include or be used in conjunction with a ReLU that generates the convolution results for that convolutional layer 402a-402c, while the last convolutional layer 402d may lack a ReLU. Note that the number of convolutional layers 402a-402d shown in FIG. 4 is for illustration only, and other numbers of convolutional layers 402a-402d may be used here. In some embodiments, each convolutional layer 402a-402d may include a 3×3 kernel that operates with a stride of one. The output of the last convolutional layer 402d may represent a local tone gain map, which identifies gains to be applied to image data of the corresponding input image 202 in order to achieve desired tone adjustments.

A multiplier function 404 multiplies the image data contained in each input image 202 with the corresponding local tone gain map for that input image 202. This is done on an element-by-element basis, meaning each pixel of an input image 202 is multiplied by a corresponding value in its local tone gain map. This results in tone adjustment data 406, which can be provided to the restoration network 206 for use as described below.

In some embodiments, given an input image 202 I_{LDR}, the tone adjustment data 406 may be defined as follows.

$${Net}_{T} ( {I}_{LDR} ) = {I}_{LDR} ⊙ {T}_{G} ( I {LDR}_{} ) = {cv}^{4} ( I {LDR}_{} )$$

Here, Net_{T}( ) represents operation of the tone network 208. Also, T_{G}(I_{LDR}) represents the local tone gain map generated using the convolutional layers 402a-402d, and cv⁴( ) represents operation of the convolutional layers 402a-402d.

Although FIG. 4 illustrates one example of a tone network 208 in the architecture 200 of FIG. 2, various changes may be made to FIG. 4. For example, various components or functions in FIG. 4 may be combined, further subdivided, replicated, omitted, or rearranged and additional components or functions may be added according to particular needs.

FIG. 5 illustrates an example restoration network 206 in the architecture 200 of FIG. 2 in accordance with this disclosure. As shown in FIG. 5, the restoration network 206 receives and processes the input images 202, and the restoration network 206 generally operates to restore details in over-exposed and/or under-exposed regions of each input image 202. The restoration network 206 uses the condition maps 312, 316, 320 from the condition network 204 to restore the lost details, and the restoration network 206 thereby supports detail restoration at multiple scales.

Each input image 202 is processed using a convolutional layer 502, which generates a feature map based on the input image 202. For each input image 202, a spatial feature transform (SFT) layer 504 processes the feature map and the condition map 312 for that input image 202. The SFT layer 504 represents a neural network layer that learns a mapping function during training to generate modulation parameters (such as affine transformation parameters) that can be used for spatial-wise feature modulation. Convolutional layers 506 and 508 apply additional convolutions to each modulated feature map, which can result in the generation of an initial intermediate feature map for each input image 202. This effectively encodes the image data of each input image 202 into the corresponding initial intermediate feature map. On the opposite end of the restoration network 206, an SFT layer 510 can generate modulation parameters for spatial-wise feature modulation based on data generated by other components of the restoration network 206, and convolutional layers 512 and 514 apply additional convolutions to the modulated data. This effectively decodes a final intermediate feature map for each input image 202 into image data for the corresponding output image 210, where the image data includes details missing from the corresponding input image 202. These components operate using the largest scale of the condition maps (meaning the condition map 312) and are used to encode low-level features and reconstruct low-level details from encoded versions of the input images 202. For each input image 202, a combiner function 516 combines the data generated by the convolutional layer 514 and the tone adjustment data 406 for that input image 202 in order to generate the corresponding output image 210.

The initial intermediate feature maps generated by the convolutional layers 506 and 508 are processed using deformable convolution residual blocks (DCRBs) 518 and 520. Also, DCRBs 522 and 524 can process data generated by other components of the restoration network 206. Here, the DCRBs 518 and 520 can be used for image encoding, and the DCRBs 522 and 524 can be used for image decoding. Each DCRB 518-524 represents logic that implements offset estimation, one or more deformable convolutions, and a spatial feature transform in a residual block. Offset estimation predicts locations of neighboring pixels to be convolved during the one or more deformable convolutions. This allows each DCRB 518-524 to learn a proper receptive field for each pixel location. The one or more deformable convolutions convolve the neighboring pixels within the receptive fields for detail restoration. A convolutional layer 526 can convolve the data generated by the DCRB 524, and a pixel shuffle (PS) layer 528 can reorganize data (such as by transforming lower-resolution image channels into larger images with smaller numbers of channels). A combiner function 530 combines the data generated by the pixel shuffle layer 528 and the data generated by the convolutional layer 506 in order to generate the data that is processed by the SFT layer 510. These components operate using the middle scale of the condition maps (meaning the condition map 316) and are used to encode mid-level features and reconstruct mid-level details from encoded versions of the input images 202.

The data generated by the DCRB 524 is processed using a convolutional layer 532, which can convolve the data. The resulting convolved data is processed using another collection of DCRBs 534-540. Here, the DCRBs 534 and 536 can be used for image encoding, and the DCRBs 538 and 540 can be used for image decoding. Again, each DCRB 534-540 represents logic that implements offset estimation, one or more deformable convolutions, and a spatial feature transform in a residual block. A combiner function 542 combines the data generated by the DCRB 540 and the data generated by the convolutional layer 532. A convolutional layer 544 can convolve the data generated by the combiner function 542, and a pixel shuffle layer 546 can reorganize the resulting data. A combiner function 548 combines the data generated by the pixel shuffle layer 546 and the data generated by the DCRB 520 in order to generate the data that is processed by the DCRB 522. These components operate using the smallest scale of the condition maps (meaning the condition map 320) and are used to encode high-level features and reconstruct high-level details from encoded versions of the input images 202.

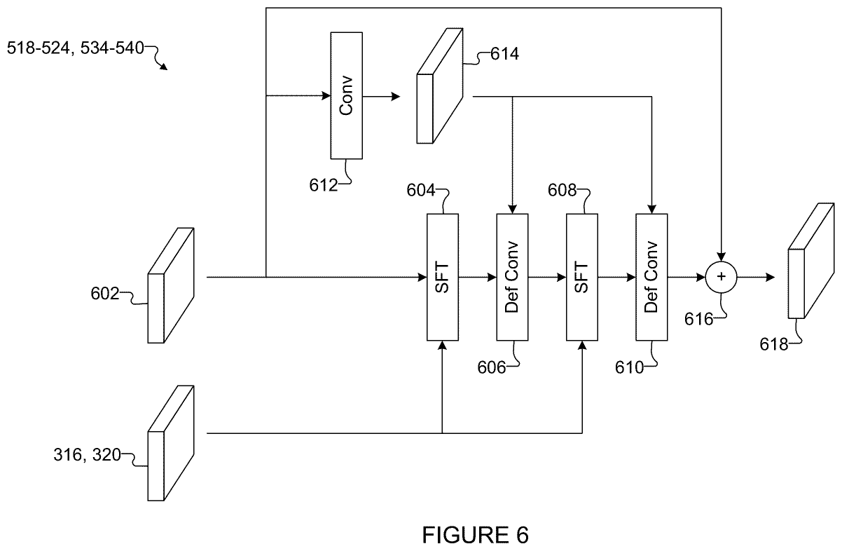

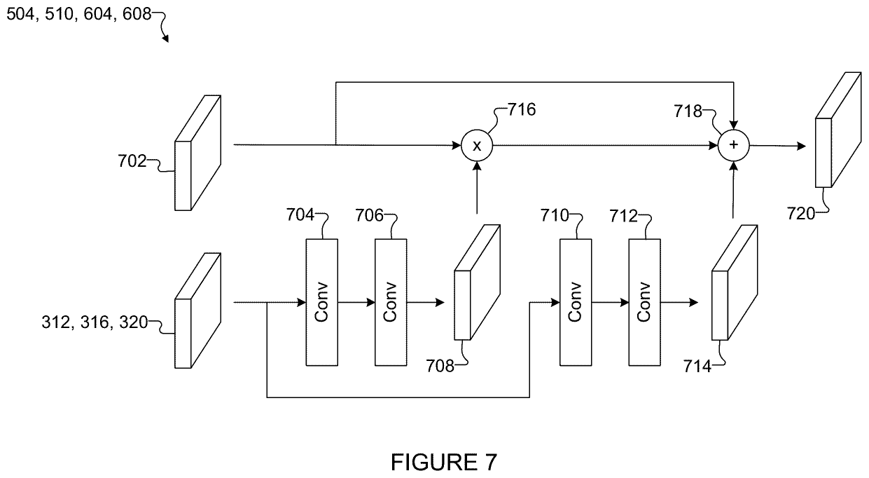

Each convolutional layer 502, 506, 508, 512, 514, 526, 532, 544 is used to extract features from input data that have been determined during training to be relevant to the specific task at hand. In some cases, each convolutional layer 502, 506, 508, 512, 514, 526, 532, 544 can include or be used in conjunction with a rectified linear unit that generates the convolution results for that convolutional layer, while the convolutional layer 514 may lack a ReLU. Note that the numbers of convolutional layers shown in FIG. 5 are for illustration only, and other numbers of convolutional layers may be used here. In some embodiments, each convolutional layer 502, 506, 512, 514, 526, 544 may include a 3×3 kernel that operates with a stride of one, and each convolutional layer 508 and 532 may include a 3×3 kernel that operates with a stride of two. Each DCRB 518-524, 534-540 is used to perform deformable convolutions, and one example embodiment of the DCRBs 518-524, 534-540 is shown in FIG. 6, which is described below. Each SFT layer 504, 510 is used to perform a spatial transform, and one example embodiment of the SFT layers 504, 510 is shown in FIG. 7, which is described below.

FIG. 6 illustrates an example DCRB 518-524, 534-540 in the restoration network 206 of FIG. 5 in accordance with this disclosure. As shown in FIG. 6, the DCRB 518-524, 534-540 receives one of the condition maps 316, 320 and an input feature map 602 for each input image 202 being processed. The input feature map 602 represents an intermediate feature map generated by the preceding component in the restoration network 206.

The input feature map 602 is processed using a first SFT layer 604, a first deformable convolutional layer 606, a second SFT layer 608, a second deformable convolutional layer 610. Each SFT layer 604, 608 can generate modulation parameters for spatial-wise feature modulation, and each deformable convolutional layer 606, 610 can perform a deformable convolution of data. The input feature map 602 is also processed using a convolutional layer 612, which generates an offset feature map 614. The offset feature map 614 contains offsets used by the deformable convolutional layers 606, 610 to perform the deformable convolutions. Estimating the correct offsets can be useful in the DCRB 518-524, 534-540 since choosing the best neighboring pixels for a deformable convolution supports learning of the receptive field on each pixel. A combiner function 616 combines the input feature map 602 and the convolution results generated by the deformable convolutional layer 610 to generate an output feature map 618.

The offset estimation performed using the convolutional layer 612 predicts the relative two-dimensional (2D) locations of k×k neighboring pixels, which are the pixels to be convolved during the deformable convolutions performed by the deformable convolutional layers 606, 610 for each pixel. In some cases, the resulting offset feature map 614 may represent a feature map with 2×k×k channels. The offset feature map 614 is applied by the deformable convolutional layers 606, 610, each of which can have a k×k filter size. In some cases, the offset feature map 614 can be expressed as follows, where [symbol] represents the input feature map 602.

o( [symbol] )=cv( [symbol] )

Here, o( [symbol] ) represents the offset feature map 614, which could have eighteen channels if the kernel size used by each of the deformable convolutional layers 606, 610 is 3×3. Also, cv( ) represents operation of the convolutional layer 612. If y represents the condition map 316 or 320, the output feature map 618 generated by the DCRB 518-524, 534-540 could be defined as follows.

$$DCRB ( z , y ) = z + dcv ( o ( z ) , SFT ( dcv ( o ( z ) , SFT ( z , y ) ) , y ) )$$

Here, DCRB( [symbol] , y) represents the output feature map 618, and SFT ( ) represents operation of each SFT layer 604, 608. Also, dcv(in₁, in₂) represents operation of each deformable convolutional layer 606, 610 based on in₁ (the offset feature map 614) and in₂ (a feature map generated by the preceding SFT layer).

In this example, the SFT layers 604, 608 and the deformable convolutional layers 606, 610 operate in a residual path to add additional details related to each input image 202 based on the offsets in the associated offset feature map 614. More specifically, the offsets are estimated directly from the input of the DCRB 518-524, 534-540 (the input feature map 602), and the same offsets are used by the first and second deformable convolutional layers 606, 610. Here, the direct inputs of the deformable convolutional layers 606, 610 have only residual information, which may not be enough to estimate accurate offsets. Because the input feature map 602 provided to the DCRB 518-524, 534-540 has more complete information, the input feature map 602 can be used to identify the offsets. Among other things, each DCRB 518-524, 534-540 may be used to improve reconstructed HDR image quality compared to prior approaches while allowing the restoration network 206 to be smaller than prior networks. This is because the DCRBs 518-524, 534-540 can restore lost detail for each pixel in an over-exposed or under-exposed region based on multiple neighboring pixels, which can be near or far away from that pixel as determined by the offset estimation.

FIG. 7 illustrates an example SFT layer 504, 510, 604, 608 in the restoration network 206 of FIG. 5 and the DCRB 518-524, 534-540 of FIG. 6 in accordance with this disclosure. As shown in FIG. 7, each SFT layer 504, 510, 604, 608 receives one of the condition maps 312, 316, 320 and an input feature map 702 for each input image 202 being processed. The input feature map 702 represents a feature map generated by the preceding component in the restoration network 206.

The input feature map 702 is processed using convolutional layers 704 and 706 to generate a first convolved feature map 708. The input feature map 702 is also processed using convolutional layers 710 and 712 to generate a second convolved feature map 714. A multiplier function 716 multiplies the input feature map 702 with the first convolved feature map 708. This is done on an element-by-element basis, where each pixel of the input feature map 702 is multiplied by a value in the first convolved feature map 708. The multiplier function 716 can thereby be used to generate a scaled feature map. A combiner function 718 combines the scaled feature map generated by the multiplier function 716 with the second convolved feature map 714. This results in the generation of a transformed feature map 720. The convolutional layers 704-706, 710-712 are used to extract features that have been determined during training to be relevant to the specific task at hand. In some cases, each convolutional layer 704, 710 can include or be used in conjunction with a leaky ReLU that generates the convolution results for the convolutional layer, and each convolutional layer 706, 712 may lack a ReLU. In some embodiments, each convolutional layer 704-706, 710-712 may include a 3×3 kernel that operates with a stride of one.

During training, the restoration network 206 learns how to restore lost details in over-exposed and/or under-exposed regions of input images using training images. However, the training images will generally have some variations. For example, there could be multiple training images that include the sky, but the sky can have many variations including different colors, textures, or cloud cover. To help the restoration network 206 learn these variations better, the SFT layers 504, 510, 604, 608 are used in FIGS. 5 and 6 at the various scales of the restoration network 206. The SFT layers 504, 510 are used at the largest scale, one on the encoder side and one on the decoder side.

At the middle and smallest scales, the SFT layers 604, 608 are used with two deformable convolutions in the various DCRBs 518-524, 534-540. The SFT layers 604, 608 help the DCRBs 518-524, 534-540 generate different details for different image contents better. Here, the SFT layers 604, 608 are modified to adopt the residual path of the corresponding DCRB 518-524. In some cases, let x and y represent the inputs for each SFT layer 604, 608, where x represents the input feature map 702 from a previous layer in the restoration network 206 and y represents one of the condition maps 312, 316, 320. Based on this, the transformed feature map 720 could be defined as follows.

$$SFT ( x , y ) = x + {cv}_{1}^{2} ( y ) ⊙ x + {cv}_{2}^{2} ( y )$$

Here, SFT (x, y) represents the transformed feature map 720. Also, cv₁²( ) represents operation of the convolutional layers 704 and 706, and cv₂²( ) represents operation of the convolutional layers 710 and 712. Using this residual style in the SFT layers 504, 510, 604, 608, training can converge in a more stable way.

Based on the networks shown in FIGS. 3 through 7, the operation of the overall architecture 200 may be defined as follows. As noted above, Net_{C}( ) represents operation of the condition network 204, and Net_{T}( ) represents operation of the tone network 208. Let Net_{R}( ) represents operation of the restoration network 206. The architecture 200 can process an LDR input image 202 and generate an HDR output image 210 using the networks 204, 206, 208 as discussed above in order to restore lost details in over-exposed and/or under-exposed regions of the LDR input image 202. The generation of the output image 210 (denoted I_{HDR}) based on the input image 202 (denoted I_{LDR}) may therefore be expressed as follows.

$${I}_{HDR} = {Net}_{DCDR} ( {I}_{LDR} ) = {Net}_{R} ( {I}_{LDR} , {Net}_{C} ( {I}_{LDR} ) ) + {Net}_{T} ( {I}_{LDR} )$$

Here, Net_{DCDR} represents the overall operation of the architecture 200.

As noted above, in order to train the architecture 200, training LDR images can be provided to the architecture 200, and HDR images generated by the architecture 200 can be compared to ground truth images. A loss can be determined based on differences between the generated images and the ground truth images, and the loss can be used to control how the architecture 200 is adjusted during training. Various loss functions can be used to determine the loss associated with the architecture 200. In some cases, a loss function can represent or be based on a combination of a pixel loss and a perceptual loss. A pixel loss refers to a loss that is based on differences between generated images and ground truth images at the pixel level, meaning pixel values of the generated images and the ground truth images are compared. A perceptual loss refers to a loss that is based on higher-level perceived differences between generated images and ground truth images, such as differences based on the content or style of the images (which may or may not be visible at the pixel level).

In some embodiments, L1 distances between predicted HDR images as generated by the architecture 200 and ground truth HDR images represent one form of pixel loss. L1 distances encapsulated with hyper-tangents (often called Tanh L1 distances) may show better restoration results than simple L1 or L2 distances, and Tanh L1 distance may be included in the loss function for the architecture 200. However, focusing only on pixel loss can result in undesirable image reconstruction. For example, restoring a dominant image region (such as the sky) in a large over-exposed region based solely on pixel loss can cause smaller objects like thin power lines or portions of trees to be reconstructed incorrectly or simply replaced by the sky. This is because the Tanh L1 loss is not adequate to emphasize small or thin objects compared to a larger over-exposed region. Combining a pixel loss with a perceptual loss can help to combat this type of issue since the use of a perceptual loss helps to restore objects in perceptually-correct ways.

In particular embodiments, the VGG loss as defined in Ledig et al., “Photo-realistic single image super-resolution using a generative adversarial network,” Proceedings of the IEEE/CVF Conference on Computer Vision and Pattern Recognition (CVPR), 2017 may be used as the perceptual loss and combined with the Tanh L1 loss. In some cases, the VGG loss can be defined as follows.

$${L}_{VGG} ( {I}_{HDR}^{pred} , {I}_{HDR}^{gt} ) = {\sum }_{( i , j ) ∈ S} \frac{1}{{W}_{i , j} {H}_{i , j}} {\sum }_{x = 1}^{{W}_{i , j}} {\sum }_{y = 1}^{{H}_{i , j}} {( {{ϕ}_{i , j} ( {I}_{HDR}^{pred} )}_{x , y} - {{ϕ}_{i , j} ( {I}_{HDR}^{gt} )}_{x , y} )}^{2}$$

Here, L_{VGG}( ) represents the VGG loss, I_{HDR} represents a predicted image generated by the architecture 200 using a training image, and I_{HDR} represents a ground truth image associated with the training image. Also, ϕ_{i,j} represents the feature map obtained by the j^{th} convolution before the i^{th} max-pooling layer in a VGG19 network, W_{i,j} and H_{i,j} represent the dimensions of ϕ_{i,j}, and S represents a set of the feature map index to be selected. Based on this, in some cases, the final loss function for the architecture 200 may be defined as follows.

$${L}_{final} ( {I}_{HDR}^{pred} , {I}_{HDR}^{gt} ) = \vert Tanh ( {I}_{HDR}^{pred} ) - Tanh ( {I}_{HDR}^{gt} ) \vert + {w}_{VGG} \cdot {L}_{VGG} ( {I}_{HDR}^{pred} , {I}_{HDR}^{gt} )$$

Here, L_{final}( ) represents the final loss value, and w_{VGG} represents a weight applied to the VGG loss in order to balance the VGG loss and the Tanh L1 loss. In some cases, w_{VGG} may equal 0.1. By attempting to minimize the overall loss, the architecture 200 can be trained to achieve detail restoration not only on large over-exposed and/or under-exposed regions but also for partially over-exposed and/or under-exposed small objects within the region(s).

Although FIGS. 5 through 7 illustrate one example of a restoration network 206 in the architecture 200 of FIG. 2 and related details, various changes may be made to FIGS. 5 through 7. For example, various components or functions in each of FIGS. 5 through 7 may be combined, further subdivided, replicated, omitted, or rearranged and additional components or functions may be added according to particular needs. As a particular example, while the restoration network 206 is shown as restoring image details at three scales, the restoration network 206 may restore image details at any other suitable number of scales.

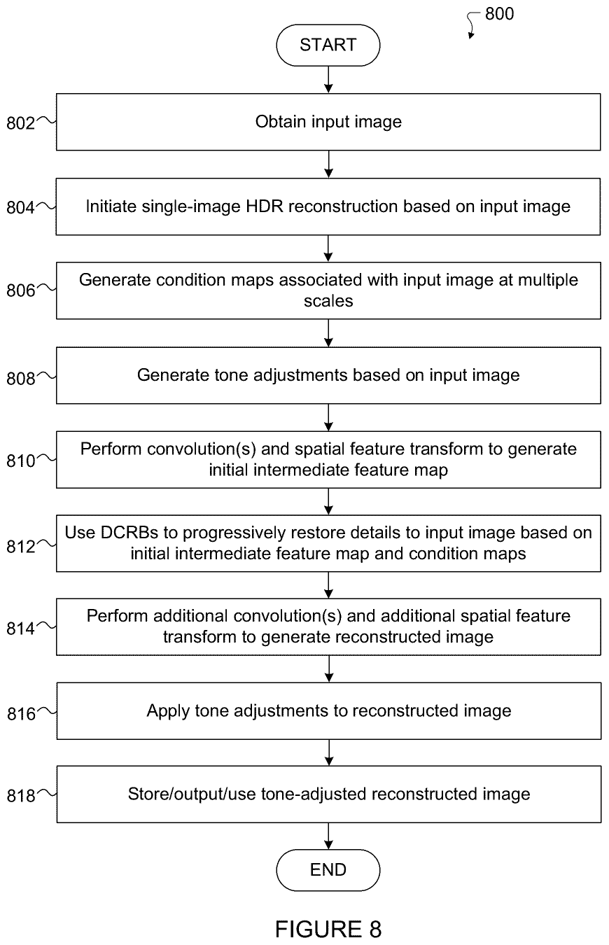

FIG. 8 illustrates an example method 800 for deformable convolution-based detail restoration for single-image HDR reconstruction in accordance with this disclosure. For ease of explanation, the method 800 shown in FIG. 8 is described as being performed by the electronic device 101 in the network configuration 100 of FIG. 1, where the electronic device 101 supports the architecture 200 shown in FIGS. 2 through 7. However, the method 800 shown in FIG. 8 could be performed using any other suitable device(s) and architecture(s) and in any other suitable system(s).

As shown in FIG. 8, an input image is obtained at step 802. This may include, for example, the processor 120 of the electronic device 101 obtaining an input image 202, which may be captured using at least one camera or other imaging sensor 180 of the electronic device 101, obtained over the Internet or other network via at least one communication interface 170 of the electronic device 101, or obtained in any other suitable manner. Single-image HDR reconstruction is initiated at step 804. This may include, for example, the processor 120 of the electronic device 101 providing the input image 202 to the architecture 200 for processing.

Condition maps associated with the input image are generated at multiple scales at step 806. This may include, for example, the processor 120 of the electronic device 101 processing the input image 202 using the condition network 204. As a particular example, this may include the processor 120 of the electronic device 101 applying the down-sampling function 302 to down-sample the input image 202 and generate a down-sampled input image. This may also include the processor 120 of the electronic device 101 applying the convolutional layers 304a-304c to perform one or more first convolutions of the down-sampled input image and generate convolution results. This may further include the processor 120 of the electronic device 101 applying the up-sampling functions 306 and 38 to up-sample the convolution results and generate first and second up-sampled convolution results. In addition, this may include the processor 120 of the electronic device 101 applying the convolutional layers 310a-310b, 314a-314b, 318a-318b to generate a first condition map 312 at a first scale using the first up-sampled convolution results, a second condition map 316 at a second scale smaller than the first scale using the second up-sampled convolution results, and a third condition map 320 at a third scale smaller than the second scale using the convolution results.

Tone adjustments associated with the input image are generated at step 808. This may include, for example, the processor 120 of the electronic device 101 processing the input image 202 using the tone network 208. As a particular example, this may include the processor 120 of the electronic device 101 applying the convolutional layers 402a-402d to the input image 202 in order to generate a local tone gain map. This may also include the processor 120 of the electronic device 101 applying the multiplier function 404 to perform an element-wise multiplication of the input image 202 and the local tone gain map in order to generate tone adjustment data 406.

One or more convolutions and a spatial feature transform are applied to the input image in order to generate an initial intermediate feature map at step 810. This may include, for example, the processor 120 of the electronic device 101 processing the input image 202 using the restoration network 206. As a particular example, this may include the processor 120 of the electronic device 101 applying the convolutional layers 502, 506, 508 and the SFT layer 504 to the input image 202. In some cases, applying the SFT layer 504 may include performing one or more first convolutions of the condition map 312 to generate a first convolved condition map, performing one or more second convolutions of the condition map 312 to generate a second convolved condition map, multiplying an input feature map by the first convolved condition map to generate a scaled feature map, and combining the scaled feature map and the second convolved condition map.

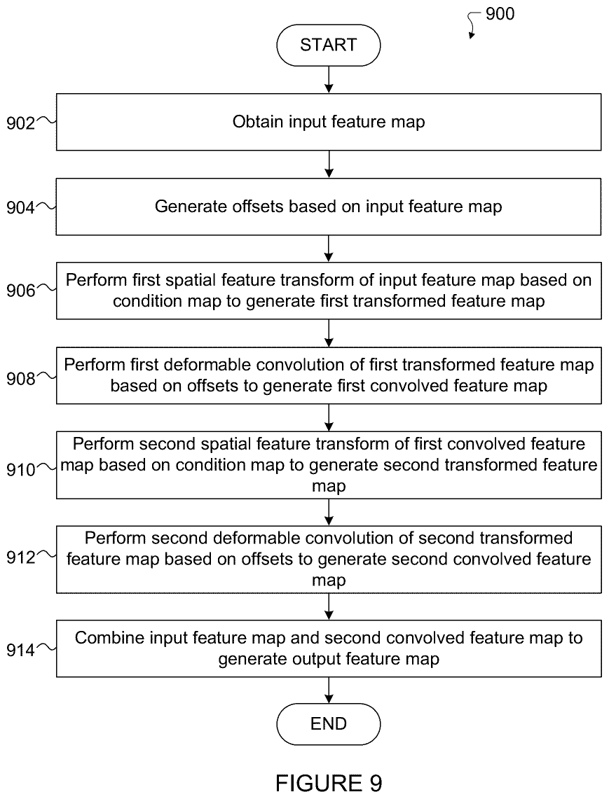

Multiple DCRBs are used to progressively restore details to the input image based on the initial intermediate feature map and the condition maps at step 812. This may include, for example, the processor 120 of the electronic device 101 using the DCRBs 518-524, 534-540 (along with related functions in the restoration network 206) to add additional details to various intermediate feature maps. This can be done using the condition maps 316 and 320. One example of how the DCRBs 518-524, 534-540 may be used is shown in FIG. 9, which is described below.

One or more additional convolutions and an additional spatial feature transform are applied to a final intermediate feature map in order to generate a reconstructed image at step 814. This may include, for example, the processor 120 of the electronic device 101 applying the SFT layer 510 and the convolutional layers 512, 514 to the final intermediate feature map generated by the preceding components in the restoration network 206. In some cases, applying the SFT layer 510 may include performing one or more first convolutions of the condition map 312 to generate a first convolved condition map, performing one or more second convolutions of the condition map 312 to generate a second convolved condition map, multiplying the input feature map by the first convolved condition map to generate a scaled feature map, and combining the scaled feature map and the second convolved condition map.

The tone adjustments are applied to the reconstructed image at step 816. This may include, for example, the processor 120 of the electronic device 101 applying the combiner function 516 to combine the tone adjustment data 406 with the reconstructed image in order to generate an HDR output image 210. The tone-adjusted reconstructed image is stored, output, or used in some manner at step 818. This may include, for example, the processor 120 of the electronic device 101 initiating presentation of the HDR output image 210 on a display 160 of the electronic device 101 or on the display of another device, storing the HDR output image 210 in the memory 130 of the electronic device 101 or in the memory of another device, or using the HDR output image 210 in any other suitable manner.

Although FIG. 8 illustrates one example of a method 800 for deformable convolution-based detail restoration for single-image HDR reconstruction, various changes may be made to FIG. 8. For example, while shown as a series of steps, various steps in FIG. 8 may overlap, occur in parallel, occur in a different order, or occur any number of times (including zero times). As a particular example, the method 800 may be repeated any number of times to process and restore details in any number of input images 202.

FIG. 9 illustrates an example method 900 for using a DCRB in accordance with this disclosure. For ease of explanation, the method 900 shown in FIG. 9 is described as being performed by the electronic device 101 in the network configuration 100 of FIG. 1, where the electronic device 101 supports at least one instance of the DCRB 518-524, 534-540 shown in FIG. 6. However, the method 900 shown in FIG. 9 could be performed using any other suitable device(s) and in any other suitable system(s).

As shown in FIG. 9, an input feature map is obtained at step 902. This may include, for example, the processor 120 of the electronic device 101 obtaining an input feature map 602, such as from an earlier layer or other component in a pipeline. Offsets are generated based on the input feature map at step 904. This may include, for example, the processor 120 of the electronic device 101 applying the convolutional layer 612 to the input feature map 602 in order to generate an offset feature map 614. The offsets identify locations of neighboring pixels to be convolved during deformable convolutions.

A first spatial feature transform of the input feature map is performed based on a condition map to generate a first transformed feature map at step 906. This may include, for example, the processor 120 of the electronic device 101 applying the SFT layer 604 to the input feature map 602. In some cases, applying the SFT layer 604 may include performing one or more first convolutions of a condition map 316 or 320 to generate a first convolved condition map, performing one or more second convolutions of the condition map 316 or 320 to generate a second convolved condition map, multiplying the input feature map 602 by the first convolved condition map to generate a scaled feature map, and combining the scaled feature map and the second convolved condition map. A first deformable convolution is applied to the first transformed feature map based on the offsets to generate a first convolved feature map at step 908. This may include, for example, the processor 120 of the electronic device 101 applying the first deformable convolutional layer 606 to the first transformed feature map.

A second spatial feature transform of the first convolved feature map is performed based on the condition map to generate a second transformed feature map at step 910. This may include, for example, the processor 120 of the electronic device 101 applying the SFT layer 608 to the first convolved feature map. In some cases, applying the SFT layer 608 may include performing one or more first convolutions of the condition map 316 or 320 to generate a first convolved condition map, performing one or more second convolutions of the condition map 316 or 320 to generate a second convolved condition map, multiplying the first convolved feature map by the first convolved condition map to generate a scaled feature map, and combining the scaled feature map and the second convolved condition map. A second deformable convolution is applied to the second transformed feature map based on the offsets to generate a second convolved feature map at step 912. This may include, for example, the processor 120 of the electronic device 101 applying the second deformable convolutional layer 610 to the second transformed feature map.

The input feature map and the second convolved feature map are combined to generate an output feature map at step 914. This may include, for example, the processor 120 of the electronic device 101 applying the combiner function 616 to combine the input feature map 602 and the second convolved feature map generated by the second deformable convolutional layer 610 to generate an output feature map 618. The output feature map 618 may be used in any suitable manner, such as by providing the output feature map 618 to the next component or components in a pipeline.

Although FIG. 9 illustrates one example of a method 900 for using a DCRB, various changes may be made to FIG. 9. For example, while shown as a series of steps, various steps in FIG. 9 may overlap, occur in parallel, occur in a different order, or occur any number of times (including zero times).

It should be noted that the functions shown in or described with respect to FIGS. 2 through 9 can be implemented in an electronic device 101, 102, 104, server 106, or other device(s) in any suitable manner. For example, in some embodiments, at least some of the functions shown in or described with respect to FIGS. 2 through 9 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 9 can be implemented or supported using dedicated hardware components. In general, the functions shown in or described with respect to FIGS. 2 through 9 can be performed using any suitable hardware or any suitable combination of hardware and software/firmware instructions. Also, the functions shown in or described with respect to FIGS. 2 through 9 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an input image; and
performing, using the at least one processing device, single-image reconstruction based on the input image to generate a reconstructed output image, the reconstructed output image having a higher dynamic range than the input image;
wherein performing the single-image reconstruction comprises restoring details to the input image based on deformable convolutions of feature maps associated with the input image.

2. The method of claim 1, wherein restoring the details to the input image comprises:
performing one or more convolutions and a spatial feature transform to generate an initial intermediate feature map;
using multiple deformable convolution residual blocks (DCRBs) to progressively restore the details to the input image, a first of the DCRBs using the initial intermediate feature map, a final one of the DCRBs generating a final intermediate feature map; and
performing one or more additional convolutions and an additional spatial feature transform based on the final intermediate feature map to generate the reconstructed output image.

3. The method of claim 2, wherein using the multiple DCRBs to progressively restore the details to the input image comprises, for each DCRB:
performing a first spatial feature transform of an input feature map based on a condition map to generate a first transformed feature map;
performing a first deformable convolution of the first transformed feature map to generate a first convolved feature map;
performing a second spatial feature transform of the first convolved feature map based on the condition map to generate a second transformed feature map; and
performing a second deformable convolution of the second transformed feature map to generate a second convolved feature map.

4. The method of claim 3, wherein using the multiple DCRBs to progressively restore the details to the input image further comprises, for each DCRB:
generating offsets based on the input feature map, the offsets identifying locations of neighboring pixels to be convolved during the first and second deformable convolutions, the DCRB performing the first and second deformable convolutions in a residual path to add additional details related to the input image based on the offsets; and
combining the input feature map and the second convolved feature map to generate an output feature map.

5. The method of claim 3, wherein performing the first spatial feature transform and performing the second spatial feature transform each comprises:
performing one or more first convolutions of the condition map to generate a first convolved condition map;
performing one or more second convolutions of the condition map to generate a second convolved condition map;
multiplying one of the input feature map or the first convolved feature map by the first convolved condition map to generate a scaled feature map; and
combining the scaled feature map and the second convolved condition map.

6. The method of claim 1, further comprising:
generating multiple condition maps at multiple scales based on the input image, the condition maps identifying regions of the input image that are over-exposed or under-exposed, wherein restoring the details to the input image comprises using the condition maps to restore details to the regions of the input image that are over-exposed or under-exposed;
wherein generating the condition maps comprises:
down-sampling the input image to generate a down-sampled input image;
performing one or more first convolutions of the down-sampled input image to generate convolution results;
up-sampling the convolution results to generate first and second up-sampled convolution results; and
generating a first condition map at a first scale using the first up-sampled convolution results, a second condition map at a second scale smaller than the first scale using the second up-sampled convolution results, and a third condition map at a third scale smaller than the second scale using the convolution results.

7. The method of claim 2, wherein a pipeline that performs the single-image reconstruction and that includes the DCRBs is trained using a loss function, the loss function representing a combination of a pixel loss and a perceptual loss.

8. An electronic device comprising:
at least one processing device configured to:
obtain an input image; and
perform single-image reconstruction based on the input image to generate a reconstructed output image, the reconstructed output image having a higher dynamic range than the input image;
wherein, to perform the single-image reconstruction, the at least one processing device is configured to restore details to the input image based on deformable convolutions of feature maps associated with the input image.

9. The electronic device of claim 8, wherein, to restore the details to the input image, the at least one processing device is configured to:
perform one or more convolutions and a spatial feature transform to generate an initial intermediate feature map;
use multiple deformable convolution residual blocks (DCRBs) to progressively restore the details to the input image, a first of the DCRBs configured to use the initial intermediate feature map, a final one of the DCRBs configured to generate a final intermediate feature map; and
perform one or more additional convolutions and an additional spatial feature transform based on the final intermediate feature map to generate the reconstructed output image.

10. The electronic device of claim 9, wherein, to use the multiple DCRBs to progressively restore the details to the input image, the at least one processing device is configured for each DCRB to:
perform a first spatial feature transform of an input feature map based on a condition map to generate a first transformed feature map;
perform a first deformable convolution of the first transformed feature map to generate a first convolved feature map;
perform a second spatial feature transform of the first convolved feature map based on the condition map to generate a second transformed feature map; and
perform a second deformable convolution of the second transformed feature map to generate a second convolved feature map.

11. The electronic device of claim 10, wherein, to use the multiple DCRBs to progressively restore the details to the input image, the at least one processing device is further configured for each DCRB to:
generate offsets based on the input feature map, the offsets identifying locations of neighboring pixels to be convolved during the first and second deformable convolutions, the DCRB configured to perform the first and second deformable convolutions in a residual path to add additional details related to the input image based on the offsets; and
combine the input feature map and the second convolved feature map to generate an output feature map.

12. The electronic device of claim 10, wherein, to perform each of the first spatial feature transform and the second spatial feature transform, the at least one processing device is configured to:
perform one or more first convolutions of the condition map to generate a first convolved condition map;
perform one or more second convolutions of the condition map to generate a second convolved condition map;
multiply one of the input feature map or the first convolved feature map by the first convolved condition map to generate a scaled feature map; and
combine the scaled feature map and the second convolved condition map.

13. The electronic device of claim 8, wherein:
the at least one processing device is further configured to generate multiple condition maps at multiple scales based on the input image, the condition maps identifying regions of the input image that are over-exposed or under-exposed;
the at least one processing device is configured to use the condition maps to restore details to the regions of the input image that are over-exposed or under-exposed; and
to generate the condition maps, the at least one processing device is configured to:
down-sample the input image to generate a down-sampled input image;
perform one or more first convolutions of the down-sampled input image to generate convolution results;
up-sample the convolution results to generate first and second up-sampled convolution results; and
generate a first condition map at a first scale using the first up-sampled convolution results, a second condition map at a second scale smaller than the first scale using the second up-sampled convolution results, and a third condition map at a third scale smaller than the second scale using the convolution results.

14. The electronic device of claim 9, wherein a pipeline that is configured to perform the single-image reconstruction and that includes the DCRBs is trained using a loss function, the loss function representing a combination of a pixel loss and a perceptual loss.

15. A method comprising:
obtaining, using at least one processing device of an electronic device, an input feature map and a condition map associated with an input image;
performing, using the at least one processing device, deformable convolutions of the input feature map based on the condition map to generate convolution results; and
generating an output feature map based on the input feature map and the convolution results, wherein the output feature map includes one or more details of the input image missing from the input feature map.

16. The method of claim 15, wherein performing the deformable convolutions comprises:
performing a first spatial feature transform of the input feature map based on the condition map to generate a first transformed feature map;
performing a first deformable convolution of the first transformed feature map to generate a first convolved feature map;
performing a second spatial feature transform of the first convolved feature map based on the condition map to generate a second transformed feature map; and
performing a second deformable convolution of the second transformed feature map to generate a second convolved feature map.

17. The method of claim 16, wherein performing the deformable convolutions further comprises:
generating offsets based on the input feature map, the offsets identifying locations of neighboring pixels to be convolved during the first and second deformable convolutions, the first and second deformable convolutions performed in a residual path to add additional details related to the input image based on the offsets.

18. The method of claim 17, wherein generating the offsets comprises:
applying at least one convolution to the input feature map.

19. The method of claim 16, wherein generating the output feature map comprises:
combining the input feature map and the second convolved feature map.

20. The method of claim 16, wherein performing the first spatial feature transform and performing the second spatial feature transform each comprises:
performing one or more first convolutions of the condition map to generate a first convolved condition map;
performing one or more second convolutions of the condition map to generate a second convolved condition map;
multiplying one of the input feature map or the first convolved feature map by the first convolved condition map to generate a scaled feature map; and
combining the scaled feature map and the second convolved condition map.
